(19) United States
(12) Patent Application Publication
(10) Pub. No.: US 2026/0036321 A1
(43) Pub. Date: Feb. 5, 2026

(54) MANAGEMENT SYSTEM, METHOD AND RECORDING MEDIUM

(71) Applicant: ZeroOne Inc., Hamamatsu-shi (JP)

(72) Inventors: Takashi UCHIYAMA, Hamamatsu-shi (JP); Shuji NIIHARA, Hamamatsu-shi (JP); Kazuya NATSUME, Hamamatsu-shi (JP); Yasunori SUGIYAMA, Hamamatsu-shi (JP)

(73) Assignee: ZeroOne Inc., Hamamatsu-shi (JP)

(21) Appl. No.: 18/901,329

(22) Filed: Sep. 30, 2024

(30) Foreign Application Priority Data
Jul. 31, 2024 (JP) 2024-124516

(51) Int. Cl. F24F 11/63; F24F 11/52; F24F 110/10; F24F 110/20; F24F 110/70; F24F 120/12; F24F 120/14; G06Q 10/0631

(52) U.S. Cl. CPC F24F 11/63; F24F 11/52; G06Q 10/06314; F24F 2110/10; F24F 2110/20; F24F 2110/70; F24F 2120/12; F24F 2120/14

(57) ABSTRACT

A management system managing an environment and a state of a target in an indoor monitoring space includes a sensor that measures a gas-related environment a sensor that measures a person present in the space; a sensor that measures a position of the target moving; a sensor that measures an operation state of equipment; a calculator that calculates a space state, from data of the measured gas-related environment and data of the measured person; a manager that manages position information of the target, in accordance with measured position data of the target; a manager that manages the operation state of the equipment; and a controller that causes a display device to display the space state, the position information of the target, and the operation state of the equipment, by superimposing the space state, the position information and the operation state on an image representing the monitoring space.

### CROSS REFERENCE TO RELATED APPLICATIONS

This application claims the benefit of Japanese Patent Application No. 2024-124516, filed on Jul. 31, 2024, the entire disclosure of which is incorporated by reference herein.

### FIELD OF THE INVENTION

This application relates generally to a management system, a method and a recording medium.

### BACKGROUND OF THE INVENTION

Conventionally, there is proposed a system that contributes to an improvement of work efficiency by recognizing a movement of a person or a thing. For example, Unexamined Japanese Patent Application Publication No. 2021-196909 that is Japanese patent literature discloses a monitoring system that analyzes states of a person, a thing and a device, from change points in the video of the person, thing and device photographed by a camera.

However, although a conventional monitoring system, as disclosed in Unexamined Japanese Patent Application Publication No. 2021-196909, can recognize whether abnormality occurs in a current work that a person, a thing or a device is performing, the conventional monitoring system cannot recognize an event other than the work, such as a space state of a working site, the presence or absence of a person, and the like.

The present disclosure has been made in consideration of the above circumstance, and the objective of the present disclosure is to provide a management system, a method and a program, which are capable of recognizing an event other than work.

### SUMMARY OF THE INVENTION

A management system according to the present disclosure is a management system that manages an environment and a state of a target in an indoor monitoring space, the management system including:
an environment measurement sensor that measures a gas-related environment in the monitoring space;
a person measurement sensor that measures a person that is present in the monitoring space;
a position measurement sensor that measures a position of the target moving in the monitoring space;
an equipment state measurement sensor that measures an operation state of equipment in the monitoring space;
a space state calculator that calculates a space state in the monitoring space, from data of the gas-related environment measured by the environment measurement sensor and data of the person measured by the person measurement sensor;
a position information manager that manages position information of the target, in accordance with position data of the target measured by the position measurement sensor;
an equipment state manager that manages the operation state of the equipment, in accordance with operation data of the equipment measured by the equipment state measurement sensor; and
a display controller that causes a display device to display the space state calculated by the space state calculator, the position information of the target managed by the position information manager, and the operation state of the equipment managed by the equipment state manager, by superimposing the space state, the position information and the operation state on an image representing a shape of the monitoring space.

[According to the present disclosure, an event other than work can be recognized.

### BRIEF DESCRIPTION OF DRAWINGS

A more complete understanding of this application can be obtained when the following detailed description is considered in conjunction with the following drawings, in which:

FIG. 1 is a diagram illustrating an example of a configuration of a management system according to an embodiment of the present disclosure;

FIG. 2 is a diagram illustrating a configuration of a controller of a control device according to the embodiment of the present disclosure;

FIG. 3 is a diagram illustrating an example of a hardware configuration of the control device according to the present embodiment;

FIG. 4 illustrates an example of a notification screen that is displayed on a display device according to the embodiment of the present disclosure;

FIG. 5 is a flowchart illustrating a flow of a management process executed in the control device according to the embodiment of the present disclosure;

FIG. 6 is a flowchart illustrating a flow of a movement process executed in the control device according to the embodiment of the present disclosure;

FIG. 7 is a flowchart illustrating a flow of an equipment state change process executed in the control device according to the embodiment of the present disclosure; and

FIG. 8 is a flowchart illustrating a flow of a space state change process executed in the control device according to the embodiment of the present disclosure.

### DETAILED DESCRIPTION OF THE INVENTION

Hereinafter, an embodiment of the present disclosure is described in detail with reference to the accompanying drawings. Note that identical or equivalent parts in the drawings are denoted by identical reference signs.

A management system 100 according to the embodiment of the present disclosure includes a function that enables recognition of events other than work in an indoor monitoring space 1, such as a space state of a working site, and the presence or absence of a person.

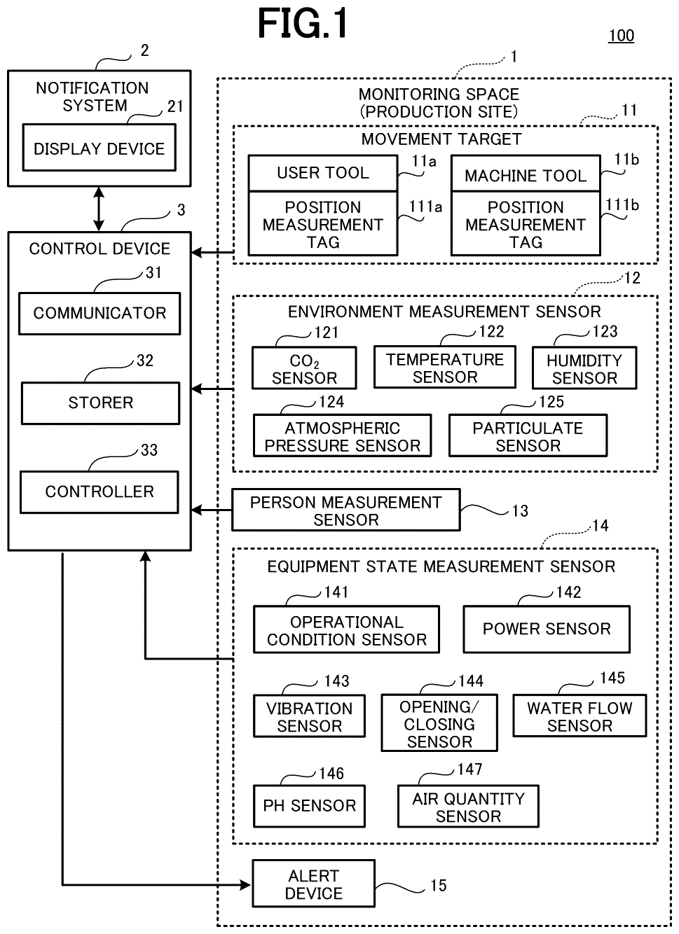

FIG. 1 is a diagram illustrating a configuration of the management system 100 including a control device 3. The management system 100 includes a movement target 11, an environment measurement sensor 12, a person measurement sensor 13, an equipment state measurement sensor 14 and an alert device 15, which are all disposed in the monitoring space 1, and also includes a notification system 2 and a control device 3. The movement target 11, environment measurement sensor 12, person measurement sensor 13, equipment state measurement sensor 14 and alert device 15, which are disposed in the monitoring space 1, the notification system 2, and the control device 3 are connected via a wired or wireless network.

The monitoring space 1 is an indoor space, and the description is given below by taking a production site of a factory as an example of the monitoring space 1 in the present embodiment. The monitoring space 1 includes the movement target 11 that moves within the space; the environment measurement sensor 12 that measures the environment in the space; the person measurement sensor 13 that measures a person present in the space; the equipment state measurement sensor 14 that measures the state of equipment disposed in the space; and the alert device 15 that issues an alert on the state of a person in the space, and the state of the equipment.

The movement target 11 is a target that moves within the monitoring space 1, and includes a user tool 11a and a machine tool 11b. The user tool 11a is a tool that a person working in the space uses in such a manner that the person carries the tool with himself/herself or holds the tool by the hand, and the user tool 11a is, for example, a helmet or a tool. The machine tool 11b is an autonomous mobile machine that is used for work in the space, and is, for example, a forklift, or an article conveying robot.

The user tool 11a and the machine tool 11b include a position measurement tag 111a and a position measurement tag 111b, respectively, which are position measurement sensors for measuring positions in the space. Hereinafter, the position measurement tag 111a and the position measurement tag 111b are comprehensively referred to as “position measurement tag 111”. As the position measurement tag 111, for example, use can be made of a radio frequency identification (RFID) tag that identifies a position by being read by a radio wave emitted from a reader, or by a reader reading a radio wave that the RFID tag emits, or an ultra wide band (UWB) tag that identifies a position from an arrival time of a radio wave emitted from the tag to a receiver.

The environment measurement sensor 12 is a sensor that measures a gas-related environment in the monitoring space 1, and acquires data of the gas-related environment. The environment measurement sensor 12 includes a CO2 sensor 121, a temperature sensor 122, a humidity sensor 123, an atmospheric pressure sensor 124, and a particulate sensor 125. The CO2 sensor 121 measures the concentration of carbon dioxide included in the atmospheric air in the space. The temperature sensor 122 measures the temperature in the space. The humidity sensor 123 measures the humidity included in the atmospheric air in the space. The atmospheric pressure sensor 124 measures the atmospheric pressure in the space. The particulate sensor 125 measures the amount of particulates included in the atmospheric air in the space.

The person measurement sensor 13 is a sensor that measures the number of persons present in the space, and the positions of the persons, and acquires data of the persons. As the person measurement sensor 13, for example, use can be made of a camera that can detect a person from information of a still image or a moving picture in the photographed space, or Light Detection And Ranging (LiDAR) that detects a distance to a target, and a shape of the target, based on information of reflective light of a radiated laser beam.

The equipment state measurement sensor 14 is a sensor that measures operation data of equipment such as manufacturing equipment, disposed in the space, for manufacturing products, and conveying equipment such as a belt conveyor that conveys products between manufacturing equipment. The equipment state measurement sensor 14 includes an operational condition sensor 141, a power sensor 142, a vibration sensor 143, an opening/closing sensor 144, a water flow sensor 145, a pH sensor 146, and an air quantity sensor 147. The operational condition sensor 141 measures an operational condition of equipment, for example, various states such as an in-operation state, a halt state, occurrence of abnormality, and the like.

The power sensor 142 measures a power state of equipment. The vibration sensor 143 measures vibration at a time when equipment is in operation. The opening/closing sensor 144 measures an opening or closing state of a door of equipment. The water flow sensor 145 measures the amount of water used for, for example, cleaning and heat radiation of products in equipment. The pH sensor 146 measures a hydrogen ion exponent of an aqueous solution used in the manufacture of a product in equipment. The air quantity sensor 147 measures the quantity of air used in the manufacture of a product in equipment, for example, the quantity of air for, for example, blowing dust and cooling a product.

The alert device 15 is a device that issues an alert to a user in regard to an operational condition of equipment, and a space state in the space, and, for example, a speaker, a rotary light, or the like can be used.

The notification system 2 is a system for notifying the user of the current environment state in the space, and includes a display device 21. The display device 21 displays the current environment state in the space. The notification system 2 can be constituted by using, for example, portable small-sized equipment such as a tablet or smartphone. Note that the notification system 2 may include a speaker for outputting alert sound, voice, or the like.

The control device 3 is, for example, a server functioning as a cloud, and includes a communicator 31, a storer 32, and a controller 33. The communicator 31 communicates with the position measurement tag 111, environment measurement sensor 12, person measurement sensor 13, equipment state measurement sensor 14 and alert device 15, which are disposed in the monitoring space 1, and with the notification system 2. The storer 32 stores various data and various programs used in the controller 33 of the control device 3.

The controller 33 calculates the space environment in the space, and the equipment state, in accordance with various data acquired from the position measurement tag 111, environment measurement sensor 12, person measurement sensor 13 and equipment state measurement sensor 14, which are disposed in the monitoring space 1. In addition, in accordance with the calculation result, the controller 33 notifies the alert device 15 in the monitoring space 1 of the operational condition of equipment and the space state in the space. Furthermore, in accordance with the calculation result, the controller 33 causes the display device 21 of the notification system 2 to display the operational condition of equipment and the space state in the space.

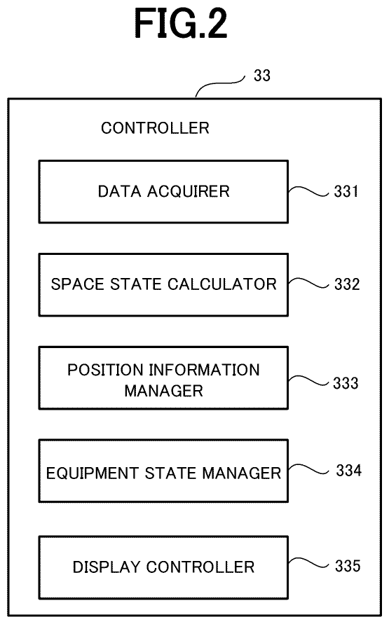

Specifically, as illustrated in FIG. 2, the controller 33 includes a data acquirer 331, a space state calculator 332, a position information manager 333, an equipment state manager 334, and a display controller 335.

The data acquirer 331 acquires various data from the position measurement tag 111, environment measurement sensor 12, person measurement sensor 13 and equipment state measurement sensor 14 in the monitoring space 1 illustrated in FIG. 1. The space state calculator 332 calculates the space state in the monitoring space 1, from the data of the gas-related environment measured by the environment measurement sensor 12, and the data of the person measured by the person measurement sensor 13.

The position information manager 333 manages the position information of the movement target 11 in the space, in accordance with the position data of the movement target 11 measured by the position measurement tag 111 illustrated in FIG. 1. The equipment state manager 334 manages the operation state of equipment, in accordance with the operation data of equipment measured by the equipment state measurement sensor 14 illustrated in FIG. 1. In addition, the equipment state manager 334 acquires a work schedule of equipment from a server or a terminal device on the outside of the control device 3, and finds a present work content and a future work schedule of equipment. The display controller 335 controls the display content of the display device 21 of the notification system 2 illustrated in FIG. 1.

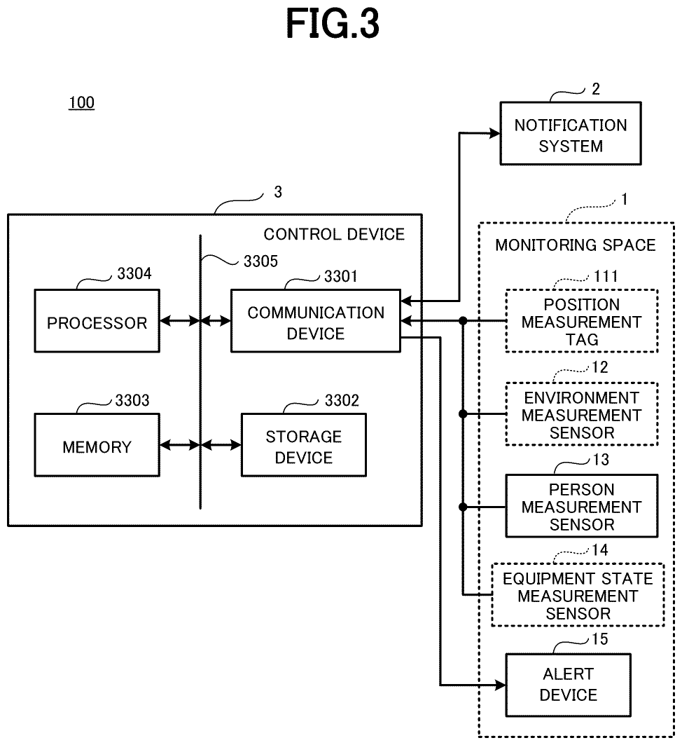

The functions in the controller 33 of the control device 3, which are illustrated in FIG. 2, are implemented by executing programs stored in the storer 32 of the control device 3 illustrated in FIG. 1. A hardware configuration of the control device 3 for executing the programs is described below, with reference to FIG. 3.

The control device 3 includes a communication device 3301, a storage device 3302, a memory 3303 and a processor 3304. The communication device 3301, storage device 3302, memory 3303 and processor 3304 are interconnected via a bus 3305.

The communication device 3301 communicates via a network with the position measurement tag 111, environment measurement sensor 12, person measurement sensor 13, equipment state measurement sensor 14 and alert device 15 in the monitoring space 1, and the notification system 2. The communication device 3301 can be constituted by, for example, various equipment including a communication system that is connectable to the network, such as a wired or wireless local area network (LAN). The storage device 3302 is a device that stores various programs executed by the processor 3304, and various data acquired by the communication device 3301 from the position measurement tag 111, environment measurement sensor 12, person measurement sensor 13 and equipment state measurement sensor 14. The storage device 3302 can be constituted by using, for example, storage equipment such as a hard disk drive (HDD) or a solid state drive (SSD).

The memory 3303 is a storage element for developing various programs stored in the storage device 3302. The memory 3303 can be constituted by using a storage element or a storage medium, for example, a volatile or nonvolatile semiconductor memory, such as a random access memory (RAM) or a flash memory. The processor 3304 reads out various programs stored in the storage device 3302, loads the various programs into the memory 3303, and executes the various programs. The processor 3304 can be constituted by using, for example, a processing device such as a central processing unit (CPU) or a micro-processing unit (MPU).

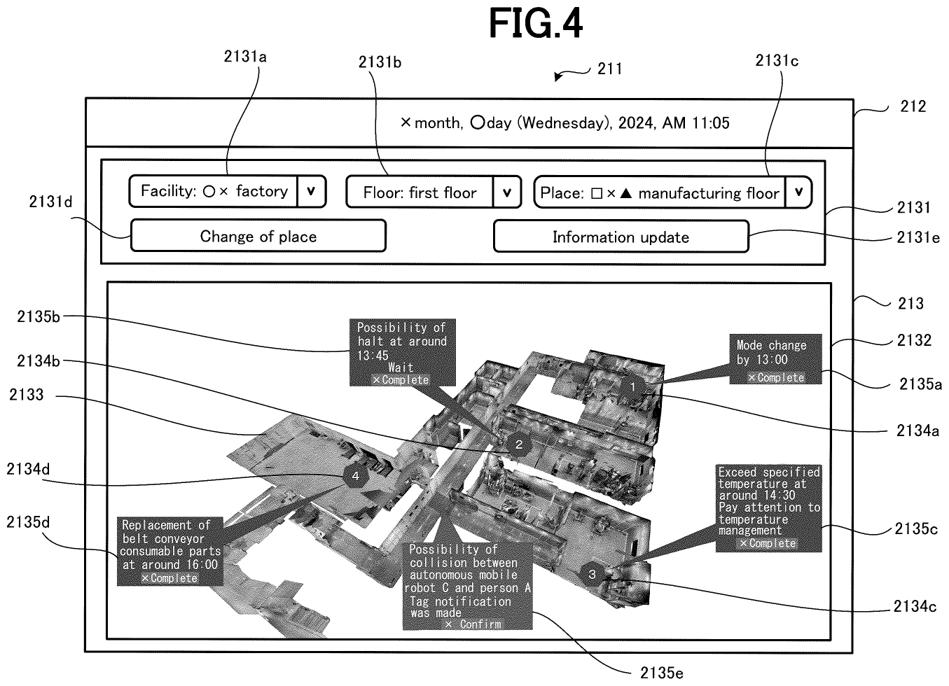

Next, FIG. 4 illustrates an example of a configuration of a notification screen 211 that is displayed on the display device 21 of the notification system 2. The notification screen 211 displays the state of the monitoring space 1. The notification screen 211 includes a date/time displayer 212 and an information presenter 213. The date/time displayer 212 displays the present date/time of the monitoring space 1. In FIG. 4, the date/time displayer 212 displays, for example, “x month, o day (Wednesday), 2024, AM 11:05”.

The information presenter 213 includes a management place selector 2131 and a video displayer 2132. The management place selector 2131 displays a button for selecting a place, the present state of which the user wishes to confirm, in the monitoring space 1 that is a management target, and also displays selection items, and the like. For example, in FIG. 4, the management place selector 2131 displays a facility selection button 2131a, a floor selection button 2131b, a place selection button 2131c, a change button 2131d, and an information update button 2131c.

The facility selection button 2131a, floor selection button 2131b and place selection button 2131c present choices of a confirmation target in a pulldown form. The change button 2131d determines the confirmation target selected by the facility selection button 2131a, floor selection button 2131b and place selection button 2131c, and changes the management target presented on the video displayer 2132. The information update button 2131e enables the user to manually update information in regard to the confirmation target selected by the facility selection button 2131a, floor selection button 2131b and place selection button 2131c.

The video displayer 2132 displays a space shape 2133, occurrence order marks 2134a to 2134d, and management information presenters 2135a to 2135e. The space shape 2133 is an image representing the shape of the monitoring space 1 of the management target. In FIG. 4, the space shape 2133 is represented by a shape of a three-dimensional stereoscopic image. Note that the space shape 2133 may be a two-dimensional planar image.

The occurrence order marks 2134a to 2134d are marks that are displayed by being superimposed on the space shape 2133, and indicate the order of events occurring in the monitoring space 1. The management information presenters 2135a to 2135e are displayed by being superimposed on the space shape 2133, and display the position information of the movement target 11, the space state in the monitoring space 1 and the operation state of equipment by the various data acquired from the position measurement tag 111, environment measurement sensor 12, person measurement sensor 13 and equipment state measurement sensor 14 illustrated in FIG. 1. In addition, the management information presenters 2135a to 2135e display a current work content or a future work schedule of equipment, which is found based on the work schedule of equipment that the equipment state manager 334 acquired from a server or a terminal device on the outside of the control device 3. Note that the management information presenters 2135a to 2135e may use a striking color such as red or yellow to easily attract the user's attention, at a time of displaying management information to which particular attention is to be paid. Besides, the management information presenters 2135a to 2135e may also display marks that call attention.

For example, in FIG. 4, the occurrence order mark 2134a is displayed on the space shape 2133 in such a shape that numeral “1” is disposed at the center of a heptagonal shape. At a position near the occurrence order mark 2134a, the management information presenter 2135a is displayed as a speech balloon including a message “Mode change by 13:00” and a “x Complete” button.

Similarly, the occurrence order mark 2134b is displayed in such a shape that numeral “2” is disposed at the center of a heptagonal shape. At a position near the occurrence order mark 2134b, the management information presenter 2135b is displayed as a speech balloon including a message “Possibility of halt at around 13:45, Wait” and a “x Complete” button.

The occurrence order mark 2134c is displayed in such a shape that numeral “3” is disposed at the center of a heptagonal shape. At a position near the occurrence order mark 2134c, the management information presenter 2135c is displayed as a speech balloon including a message “Exceed specified temperature at around 14:30, Pay attention to temperature management” and a “x Complete” button.

In addition, the occurrence order mark 2134d is displayed in such a shape that numeral “4” is disposed at the center of a heptagonal shape. At a position near the occurrence order mark 2134d, the management information presenter 2135d is displayed as a speech balloon including a message “Replacement of belt conveyor consumable parts at around 16:00” and a “x Complete” button.

Besides, the management information presenter 2135e does not have the occurrence order marks 2134a to 2134d, and is displayed as a speech balloon including a message “Possibility of collision between autonomous mobile robot C and person A, Tag notification was made” and a “x Confirm” button. This is because the urgent content as in the management information presenter 2135e needs to be addressed with top priority, regardless of the occurrence order.

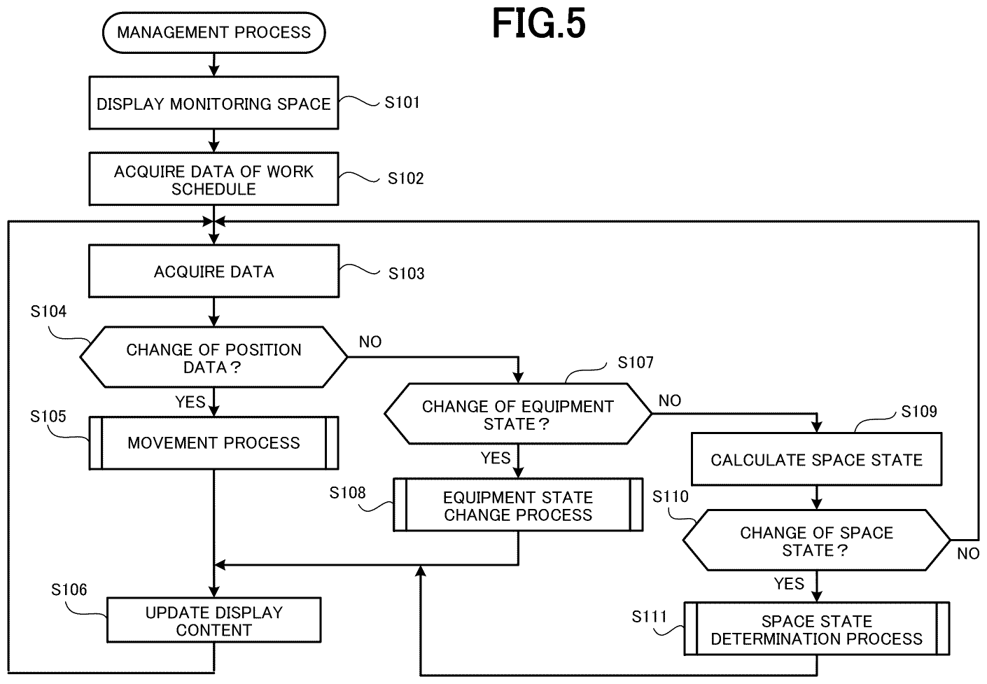

Next, a management process in the present embodiment is described below with reference to flowcharts of FIG. 5 to FIG. 8. The management process is stored as a management process program in the storer 32 of the control device 3 illustrated in FIG. 1. The management process program is started at a timing when the control device 3 is started. Specifically, the processor 3304 reads out the management process program stored in the storage device 3302 of the control device 3 illustrated in FIG. 3, loads the management process program into the memory 3303, and executes the management process program.

The display controller 335 of the controller 33 of the control device 3 illustrated in FIG. 2 causes the notification screen 211, which is displayed on the display device 21 of the notification system 2, to display the space shape 2133 of the monitoring space 1 that is the management target (step S101). Specifically, the display controller 335 sets, as the management target, the monitoring space 1 that the user selected by the facility selection button 2131a, floor selection button 2131b and place selection button 2131c on the management place selector 2131 of the notification screen 211 illustrated in FIG. 4, and causes the display device 21 of the notification system 2 to display the space shape 2133.

The equipment state manager 334 of the controller 33 of the control device 3 illustrated in FIG. 2 acquires a work schedule of equipment from the server or terminal device on the outside of the control device 3 (step S102). The data acquirer 331 of the controller 33 of the control device 3 acquires various data from the position measurement tag 111, environment measurement sensor 12, person measurement sensor 13 and equipment state measurement sensor 14 in the monitoring space 1 illustrated in FIG. 1 (step S103).

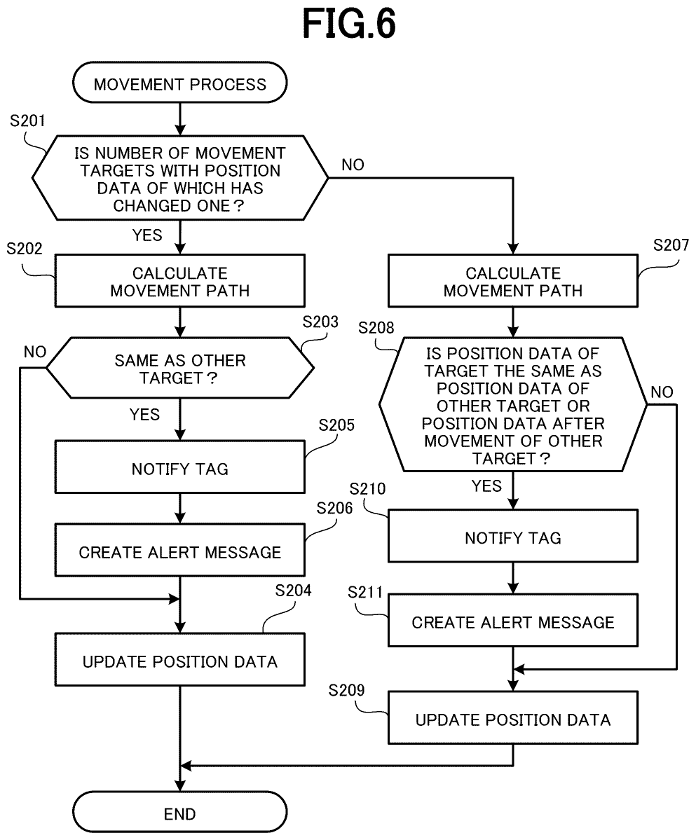

The position information manager 333 of the controller 33 of the control device 3 determines whether the position data of the movement target 11 measured by the position measurement tag 111 illustrated in FIG. 1 has changed (step S104). If the position data of the movement target 11 has changed (step S104; YES), the position information manager 333 executes a movement process (step S105). The operation content of the movement process (step S105) is described below with reference to a flowchart of FIG. 6.

The position information manager 333 determines whether the number of movement targets 11 with the position data of which has changed is one (step S201). If the number of movement targets 11 with the position data of which has changed is one (step S201; YES), the position information manager 333 calculates a movement path from position data before and after the movement of this one movement target 11 (step S202).

The position information manager 333 determines whether the position data of the movement target 11 measured by the position measurement tag 111 is the same as the position data of some other movement target 11 (step S203). If the position data of the movement target 11 is different from the position data of the other movement target 11 (step S203; NO), the position information manager 333 determines that the movement target 11 is not in contact with the other movement target 11. The position information manager 333 updates the position data of the movement target 11 to position data after the movement (step S204).

In addition, if the position data of the movement target 11 is the same as the position data of the other movement target 11 (step S203; YES), the position information manager 333 notifies the position measurement tags 111 of the movement target 11 and the other movement target 11 that the movement target 11 is in contact with the other movement target 11 (step S205).

The position information manager 333 creates an alert message (step S206). For example, the position information manager 333 creates a message, such as “Possibility of collision between autonomous mobile robot C and person A Tag notification was made”, as in the management information presenter 2135e illustrated in FIG. 4. The position information manager 333 updates the position data of the movement target 11 to position data after the movement (step S204).

In addition, in step S201, if the number of movement targets 11 with the position data of which has changed is plural (step S201; NO), the position information manager 333 calculates a movement path from position data before and after the movement in regard to each of the plural movement targets 11 (step S207). The position information manager 333 determines whether the position data of the movement target 11 measured by the position measurement tag 111 is the same as the position data of some other movement target 11 or the position data after the movement of the other movement target 11 (step S208).

If the position data of the movement target 11 is different from the position data of the other movement target 11 or the position data after the movement of the other movement target 11 (step S208; NO), the position information manager 333 determines that the movement target 11 is not in contact with the other movement target 11. The position information manager 333 updates the position data of the movement target 11 to position data after the movement (step S209).

In addition, in step S208, if the position data of the movement target 11 is the same as the position data of the other movement target 11 or the position data after the movement of the other movement target 11 (step S208; YES), the position information manager 333 notifies the position measurement tags 111 of the movement target 11 and the other movement target 11 that the movement target 11 is in contact with the other movement target 11 (step S210).

The position information manager 333 creates an alert message (step S211). The position information manager 333 updates the position data of the movement target 11 to position data after the movement (step S209). The position information manager 333 terminates the movement process.

The description returns to FIG. 5. The display controller 335 of the controller 33 of the control device 3 illustrated in FIG. 2 updates the display content of the notification screen 211 displayed on the display device 21 of the notification system 2 (step S106). For example, the display controller 335 causes the alert message created in step S206 or step S211 of FIG. 6 to be displayed, by superimposing the alert message on the space shape 2133 of the monitoring space 1 of the management target displayed on the notification screen 211. Returning to step S103, the data acquirer 331 of the controller 33 of the control device 3 executes step S103 onwards.

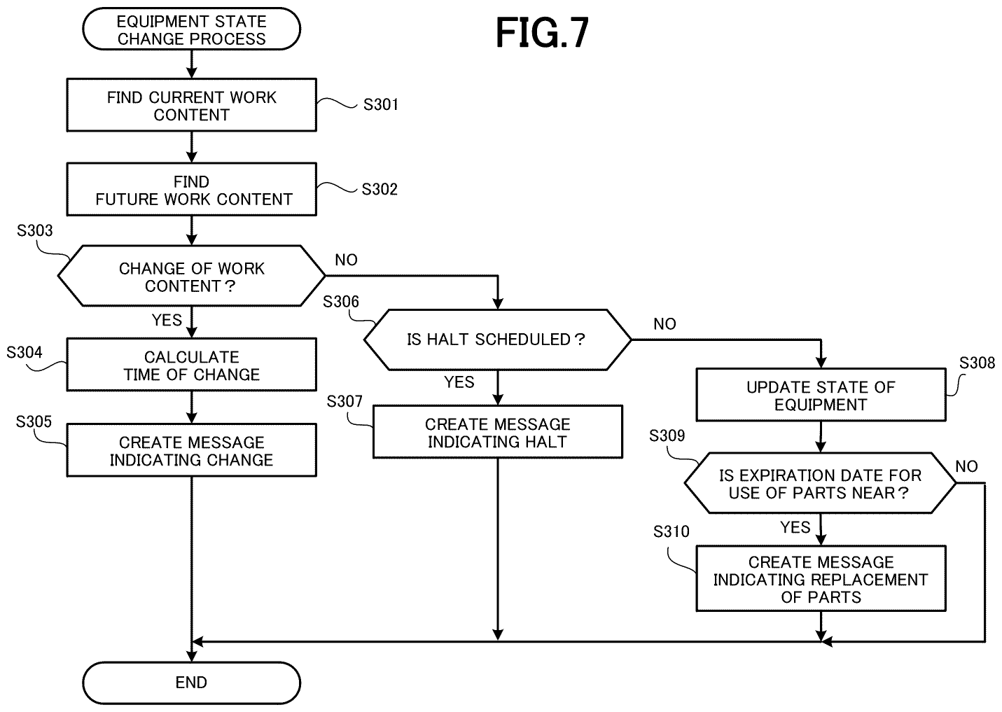

In addition, in step S104, if the position data of the movement target 11 measured by the position measurement tag 111 illustrated in FIG. 1 does not change (step S104; NO), the equipment state manager 334 of the controller 33 of the control device 3 illustrated in FIG. 2 determines whether the equipment state in the monitoring space 1 has changed (step S107). If the equipment state has changed (step S107; YES), the equipment state manager 334 executes an equipment state change process (step S108). The equipment state change process (step S108) is described below with reference to a flowchart illustrated in FIG. 7.

The equipment state manager 334 calculates an equipment state from various data acquired from the equipment state measurement sensor 14 in step S103 of FIG. 5. The equipment state manager 334 finds the current work content of equipment, based on the calculated equipment state (step S301). Specifically, the equipment state manager 334 finds the current work content of equipment, by collating the work schedule of equipment acquired from the server or terminal device on the outside of the control device 3 in step S102 of FIG. 5, and the calculated equipment state.

The equipment state manager 334 finds the future work content of equipment, based on the equipment state calculated in step S301 and the work schedule of equipment (step S302). Specifically, the equipment state manager 334 finds the work content of equipment after a predetermined time, for example, after one hour, by using as a starting point the current work content of equipment found from the calculated equipment state and the work schedule of equipment.

The equipment state manager 334 determines whether the future work content of equipment changes from the current work content (step S303). If the work content changes (step S303; YES), the equipment state manager 334 calculates a time at which the work content changes, from the present time and the work schedule of equipment (step S304). The equipment state manager 334 creates a message indicating that the work content changes (step S305). For example, the equipment state manager 334 creates a message such as “Mode change by 13:00” as in the management information presenter 2135a illustrated in FIG. 4.

In addition, in step S303, if the future work content of equipment does not change from the current work content (step S303; NO), the equipment state manager 334 determines whether the equipment is scheduled to halt (step S306). If the equipment is scheduled to halt (step S306; YES), the equipment state manager 334 creates a message indicating the halt (step S307). For example, the equipment state manager 334 creates a message such as “Possibility of halt at around 13:45, Wait” as in the management information presenter 2135b illustrated in FIG. 4.

If the equipment is not scheduled to halt (step S306; NO), the equipment state manager 334 updates the equipment state, based on the equipment state calculated in step S301 (step S308). The equipment state manager 334 determines whether the expiration date for use of parts of equipment is near (step S309).

If the expiration date for use of parts of equipment is near (step S309; YES), the equipment state manager 334 creates a message indicating replacement of parts (step S310). For example, the equipment state manager 334 creates a message such as “Replacement of belt conveyor consumable parts at around 16:00” as in the management information presenter 2135d illustrated in FIG. 4. On the other hand, if the expiration date for use of parts of equipment is not near (step S309; NO), the equipment state manager 334 terminates the equipment state change process.

The description returns to FIG. 5. The display controller 335 of the controller 33 of the control device 3 illustrated in FIG. 2 updates the display content of the notification screen 211 displayed on the display device 21 of the notification system 2 (step S106). For example, the display controller 335 causes the message created in step S305 of FIG. 7 to the effect that the work content changes, the message indicating the halt created in step S307, or the message indicating replacement of parts created in step S310, to be displayed, by superimposing the messages on the space shape 2133 of the monitoring space 1 of the management target displayed on the notification screen 211. Returning to step S103, the data acquirer 331 of the controller 33 of the control device 3 executes step S103 onwards.

In addition, in step S107, if the equipment state in the monitoring space 1 does not change (step S107; NO), the space state calculator 332 of the controller 33 illustrated in FIG. 2 calculates the space state in the monitoring space 1, from various data acquired from the environment measurement sensor 12 in step S103 (step S109). The space state calculator 332 determines whether the calculated space state has changed from the space state before the calculation (step S110).

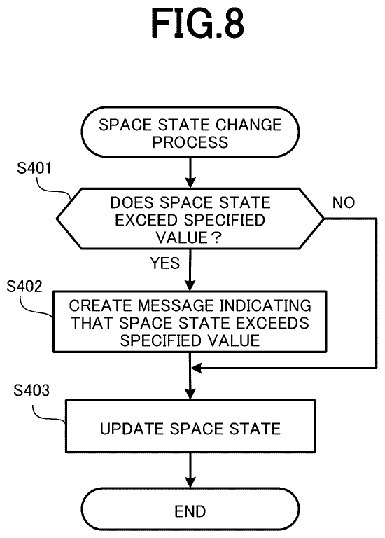

If the calculated space state does not change from the space state before the calculation (step S110; NO), the process returns to step S103, and the data acquirer 331 of the controller 33 of the control device 3 executes step S103 onwards. On the other hand, if the calculated space state has changed from the space state before the calculation (step S110; YES), the space state calculator 332 executes a space state determination process (step S111). The space state determination process (step S111) is described below with reference to a flowchart of FIG. 8.

The space state calculator 332 determines whether the calculated space state exceeds a specified value (step S401). For example, it is assumed that the temperature in the space measured by the temperature sensor 122 of the environment measurement sensor 12 illustrated in FIG. 1 exceeds a specified value of the temperature. In this case, since the calculated space state exceeds the specified value (step S401; YES), the space state calculator 332 creates a message indicating that the space state exceeds the specified value (step S402). For example, the equipment state manager 334 creates a message such as “Exceed specified temperature at around 14:30, Pay attention to temperature management” as in the management information presenter 2135c illustrated in FIG. 4.

The space state calculator 332 updates the data of the space state by the data of the calculated space state (step S403). In addition, in step S401, for example, it is assumed that the temperature in the space measured by the temperature sensor 122 of the environment measurement sensor 12 illustrated in FIG. 1 does not exceed the specified value of the temperature. In this case, since the calculated space state does not exceed the specified value (step S401; NO), the space state calculator 332 updates the data of the space state by the data of the calculated space state (step S403). The space state calculator 332 terminates the space state change process.

The description returns to FIG. 5. The display controller 335 of the controller 33 of the control device 3 illustrated in FIG. 2 updates the display content of the notification screen 211 displayed on the display device 21 of the notification system 2 (step S106). For example, the display controller 335 causes the message created in step S402 of FIG. 8 to the effect that the space state exceeds the specified value to be displayed, by superimposing the message on the space shape 2133 of the monitoring space 1 of the management target displayed on the notification screen 211. Returning to step S103, the data acquirer 331 of the controller 33 of the control device 3 executes step S103 onwards.

As described above, according to the management system 100 relating to the present embodiment, events other than work in the indoor monitoring space 1, such as a space state of a working site, and the presence or absence of a person, can be recognized.

### (Modifications)

In the above-described embodiment, the production site of the factory was described as an example of the monitoring space 1. Aside from this, the monitoring space 1 may be any kind of space where many persons or things enter and exit, for example, a floor of a hospital, a theater, a cinema, a hall, a department store, or a commercial facility such as a shopping mall.

In addition, in the above-described embodiment, it was assumed that the control device 3 is a server functioning as a cloud. Aside from this, the control device 3 may be a stand-alone computer.

Additionally, in the above-described embodiment, in the space state change process of FIG. 8, the temperature was described as an example of the space state. Aside from this, the change of the space state may be determined based on at least one of, or a plurality of, a carbon dioxide concentration, humidity, atmospheric pressure, and particulates, which are acquired by the sensors included in the environment measurement sensor 12.

Additionally, in the above-described embodiment, a two-dimensional code for work content management, which can manage the work content and the work steps on a slip-by-slip basis, may be prepared, and the two-dimensional code may be read by a read device such as a bar code reader or a scanner, and thereby the current work content and work steps and the future work content and work steps can be managed.

Additionally, in the above-described embodiment, it is assumed that the movement target 11 is a target moving in the monitoring space 1, and includes the user tool 11a and machine tool 11b. Aside from this, the movement target 11 may include transportation items, parts, products in process, and finished products, which move in the monitoring space 1.

Additionally, in the above-described embodiment, although the configuration including the function of notifying the position measurement tag 111 of close proximity information or the like was described, a configuration without the function of notifying the position measurement tag 111 of close proximity information or the like may be implemented. In this case, for example, the position measurement tag 111 is utilized for position information acquisition, and the notification to the user is implemented by a message displayed on the notification system 2 or alert sound, or by the alert device 15, such as a speaker or a rotary light, which is disposed in the monitoring space 1.

Additionally, the method of application of a program in the present embodiment is freely chosen. For example, the program can be applied by being stored in a non-transitory computer-readable storage medium such as a flexible disc, a CD (Compact Disc)-ROM, a DVD (Digital Versatile Disc)-ROM, or a memory card. Furthermore, the program may be superimposed on a carrier wave, and can be applied via a communication medium such as the internet. For example, the program may be delivered by being posted on a Bulletin Board System (BBS) on a communication network. In addition, such a configuration may be adopted that a display selection process program is started and executed like other application programs under the control of an Operating System (OS), and thereby the above-described process can be executed.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.
1 Monitoring space
2 Notification system
3 Control device
11 Movement target
11a User tool
11b Machine tool
12 Environment measurement sensor
13 Person measurement sensor
14 Equipment state measurement sensor
15 Alert device
21 Display device
31 Communicator
32 Storer
33 Controller
100 Management system
111, 111a, 111b Position measurement tag
121 CO2 sensor
122 Temperature sensor
123 Humidity sensor
124 Atmospheric pressure sensor
125 Particulate sensor
141 Operational condition sensor
142 Power sensor
143 Vibration sensor
144 Opening/closing sensor
145 Water flow sensor
146 pH sensor
147 Air quantity sensor
211 Notification screen
212 Date/time displayer
213 Information presenter
331 Data acquirer
332 Space state calculator
333 Position information manager
334 Equipment state manager
335 Display controller
2131 Management place selector
2131a Facility selection button
2131b Floor selection button
2131c Place selection button
2131d Change button
2131e Information update button
2132 Video displayer
2133 Space shape
2134a, 2134b, 2134c, 2134d, 2134a˜2134d Occurrence order mark
2135a, 2135b, 2135c, 2135d, 2135e, 2135a˜2135e Management information presenter
3301 Communication device
3302 Storage device
3303 Memory
3304 Processor
3305 Bus

What is claimed is:

1. A management system that manages an environment and a state of a target in an indoor monitoring space, the management system comprising:
an environment measurement sensor that measures a gas-related environment in the monitoring space;
a person measurement sensor that measures a person that is present in the monitoring space;
a position measurement sensor that measures a position of the target moving in the monitoring space;
an equipment state measurement sensor that measures an operation state of equipment in the monitoring space;
a space state calculator that calculates a space state in the monitoring space, from data of the gas-related environment measured by the environment measurement sensor and data of the person measured by the person measurement sensor;
a position information manager that manages position information of the target, in accordance with position data of the target measured by the position measurement sensor;
an equipment state manager that manages the operation state of the equipment, in accordance with operation data of the equipment measured by the equipment state measurement sensor; and
a display controller that causes a display device to display the space state calculated by the space state calculator, the position information of the target managed by the position information manager, and the operation state of the equipment managed by the equipment state manager, by superimposing the space state, the position information and the operation state on an image representing a shape of the monitoring space.

2. The management system according to claim 1, wherein
the space state calculator calculates at least one of a temperature, a humidity, a carbon dioxide concentration and particulates in the monitoring space, based on the space state in the monitoring space calculated by the space state calculator, and determines whether a calculated value is equal to or more than, or is less than, a specified value, and
the display controller causes the display device to display a message corresponding to a determination result of the space state calculator.

3. The management system according to claim 1, wherein
the position information manager calculates a movement path of the target, based on a change of the position data of the target measured by the position measurement sensor, and
the display controller causes the display device to display a position of the target after movement, in accordance with the movement path of the target calculated by the position information manager.

4. The management system according to claim 3, wherein in a case where the position data of the target measured by the position measurement sensor is identical to position data of another target, the position information manager causes the display controller to display on the display device a message indicating a contact between the target and the another target.

5. The management system according to claim 1, wherein
the equipment state manager finds a current work content or a future work content of the equipment, from the operation state of the equipment measured by the equipment state measurement sensor, and a work schedule of the equipment, and
the display controller causes the display device to display the current work content or the future work content of the equipment found by the equipment state manager.

6. The management system according to claim 1, wherein
the equipment state manager calculates an expiration date for use of parts used in the equipment, from the operation state of the equipment measured by the equipment state measurement sensor, and a work schedule of the equipment, and determines whether the expiration date for use of the parts is near, and
the display controller causes the display device to display a message corresponding to a determination result of the equipment state manager.

7. The management system according to claim 1, wherein the image representing the shape of the monitoring space is a shape of a stereoscopic image.

8. A method that a management system including a memory storing a program and a processor, and managing an environment and a state of a target in an indoor monitoring space executes, the processor executing the program to implement:
measuring a gas-related environment in the monitoring space;
measuring a person that is present in the monitoring space;
measuring a position of the target moving in the monitoring space;
measuring an operation state of equipment in the monitoring space;
calculating a space state in the monitoring space, from data of the measured gas-related environment and data of the measured person;
managing position information of the target, in accordance with measured position data of the target;
managing the operation state of the equipment, in accordance with the measured operation state of the equipment; and
displaying the calculated space state in the monitoring space, the managed position information of the target, and the managed operation state of the equipment, by superimposing the calculated space state, the managed position information and the managed operation state on an image representing a shape of the monitoring space.

9. A non-transitory recording medium storing a program for causing a computer to execute:
a process of measuring a gas-related environment in a monitoring space;
a process of measuring a person that is present in the monitoring space;
a process of measuring a position of a target moving in the monitoring space;
a process of measuring an operation state of equipment in the monitoring space;
a process of calculating a space state in the monitoring space, from data of the measured gas-related environment and data of the measured person;
a process of managing position information of the target, in accordance with measured position data of the target;
a process of managing the operation state of the equipment, in accordance with the measured operation state of the equipment; and
a process of displaying the calculated space state in the monitoring space, the managed position information of the target, and the managed operation state of the equipment, by superimposing the calculated space state, the managed position information and the managed operation state on an image representing a shape of the monitoring space.
